(19) United States
(12) Patent Application Publication
(10) Pub. No.: US 2026/0321482 A1
(43) Pub. Date: Oct. 15, 2026

(54) Symmetric planar transformer

(71) Applicant: Texas Instruments Incorporated, Dallas, TX (US)

(72) Inventors: Nicola Bertoni, FREISING (DE); Giacomo Calabrese, Freising (DE); M L Sriharsha, HINDUPUR (IN)

(21) Appl. No.: 19/648,363

(22) Filed: Apr. 15, 2026

Related U.S. Application Data
(60) Provisional application No. 63/789,086, filed on Apr. 15, 2025.

(51) Int. Cl. H01F 27/28; H01F 27/29

(52) U.S. Cl. CPC H01F 27/2804; H01F 27/292; H01F 27/2809; H01F 27/2819

(57) ABSTRACT

An apparatus includes include a substrate including a first metal layer and a second metal layer isolated by one or more dielectric layers. The first metal layer includes a first coil formed therein. The first coil has two terminals and includes two spiral windings that are mirror-symmetric with respect to an axis and form a figure-of-B winding structure. Each terminal of the two terminals of the first coil is surrounded by a respective spiral winding of the two spiral windings of the first coil. The second metal layer includes a second coil formed therein. The second coil has two terminals and includes two spiral windings that are mirror-symmetric with respect to the axis and form a figure-of-B winding structure. Each terminal of the two terminals of the second coil is surrounded by a respective spiral winding of the two spiral windings of the second coil.

### CROSS-REFERENCE TO RELATED APPLICATION

This application claims the benefit of and priority to U.S. Provisional Application No. 63/789,086, filed Apr. 15, 2025, entitled “2-layer Symmetric Planar Transformer,” which is hereby incorporated by reference in its entirety for all purposes.

### BACKGROUND

Some electrical systems may use isolation circuits between an input and an output to, for example, protect users or circuits from high voltages, eliminate ground loops that may cause interference, allow different ground potentials, and prevent a fault on one side from damaging another side, while still allowing data or power exchange between the input and output. For example, an isolated direct current (DC)-DC power converter may provide galvanic isolation between different power domains, such as between high-voltage and low-voltage domains, or between analog and digital domains. Galvanic isolation may prevent direct current flow between the input and output while still allowing energy or signal transfer between them, for example, through inductive coupling (e.g., using transformers), capacitive coupling (e.g., using capacitors), optical coupling (e.g., using optocouplers), or acoustic coupling (e.g., using acoustic transducers).

### SUMMARY

This Summary is provided to introduce examples of disclosed concepts in a simplified form, which are further described below in the Detailed Description including the drawings provided.

According to some examples, an apparatus may include a substrate including a first metal layer and a second metal layer isolated by one or more dielectric layers. The first metal layer includes a first coil formed therein. The first coil has two terminals and includes two spiral windings that are mirror-symmetric with respect to an axis. Each terminal of the two terminals of the first coil is surrounded by a respective spiral winding of the two spiral windings of the first coil. The second metal layer includes a second coil formed therein. The second coil has two terminals and includes two spiral windings that are mirror-symmetric with respect to the axis. Each terminal of the two terminals of the second coil is surrounded by a respective spiral winding of the two spiral windings of the second coil.

According to some examples, an apparatus may include a substrate including a first metal layer, a second metal layer, and one or more dielectric layers between the first metal layer and the second metal layer. The first metal layer includes a first coil formed therein. The first coil includes two spiral windings that are mirror-symmetric with respect to an axis and are connected by a coil segment to form a first figure-of-B winding structure. The second metal layer includes a second coil formed therein. The second coil includes two spiral windings that are mirror-symmetric with respect to the axis and are connected by a coil segment to form a second figure-of-B winding structure.

According to some examples, an apparatus may include: a substrate including a first section and a second section isolated from the first section; a first semiconductor die mounted on the first section; a second semiconductor die mounted on the second section; and a transformer coupled between the first semiconductor die and the second semiconductor die. The transformer includes a first metal layer and a second metal layer. The first metal layer includes a first coil formed therein. The first coil has two terminals and includes two spiral windings that are mirror-symmetric with respect to an axis. Each terminal of the two terminals of the first coil is surrounded by a respective spiral winding of the two spiral windings of the first coil. The second metal layer is isolated from the first metal layer by at least one dielectric layer. The second metal layer includes a second coil formed therein. The second coil has two terminals and includes two spiral windings that are mirror-symmetric with respect to the axis. Each terminal of the two terminals of the second coil is surrounded by a respective spiral winding of the two spiral windings of the second coil.

The foregoing summary outlines rather broadly various features of examples of the present disclosure so that the following detailed description may be better understood. Additional features and advantages of such examples will be described hereinafter. This summary is neither intended to identify key or essential features of the claimed subject matters, nor is it intended to be used in isolation to determine the scope of the claimed subject matters. The subject matters should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative examples are described in detail below with reference to the following figures.

FIG. 1 is a block diagram of an example of a packaged integrated circuit (IC) including two semiconductor dies and an integrated isolation circuit, according to some examples.

FIG. 2 is a block diagram of an example of a packaged IC having an integrated isolation circuit including inductive isolation channels coupled to two or more semiconductor dies, according to some examples.

FIG. 3A is a cross-sectional view of an example of a device including an isolation circuit that includes a planar transformer.

FIG. 3B is a top view of an example of the planar transformer in the device of FIG. 3A.

FIG. 3C is a top view of another example of a planar transformer of an isolation circuit.

FIG. 4A is a top view of an example of a planar transformer including two coils each having a figure-of-B winding structure, according to some examples.

FIG. 4B is a top view of another example of a planar transformer including two coils each having a figure-of-B winding structure, according to some examples.

FIG. 4C is a top view of another example of a planar transformer including two coils each having a figure-of-B winding structure, according to some examples.

FIG. 5 is a perspective view of an example of a packaged device including an isolation circuit that includes a planar transformer having two coils with figure-of-B winding structures, according to some examples.

FIG. 6 is a top view of another example of a packaged device including at least one isolation circuit that includes a planar transformer having two coils with figure-of-B winding structures, according to some examples.

FIG. 7A is a perspective view of an example of an isolation circuit that includes a planar transformer having two coils with figure-of-B winding structures formed in two metal layers, according to some examples.

FIG. 7B is a perspective view of an example of an isolation circuit that includes a planar transformer having two coils with figure-of-B winding structures formed in three metal layers, according to some examples.

The drawings and accompanying detailed description are provided for understanding of features of various examples and do not limit the scope of the appended claims. The examples illustrated in the drawings and described in the accompanying detailed description may be readily utilized as a basis for modifying or designing other examples that are within the scope of the appended claims. One skilled in the art will readily recognize from the following description that alternative embodiments of the structures and methods illustrated may be employed without departing from the principles, or benefits touted, of this disclosure. Identical reference numerals may be used, where possible, to designate identical elements that are common among drawings. The figures are drawn to clearly illustrate the relevant elements or features and are not necessarily drawn to scale.

### DETAILED DESCRIPTION

The present disclosure relates generally to planar transformers, and more specifically, to integrated symmetric planar transformers implemented using two or more metal layers in a substrate. The symmetric planar transformers may include coils having figure-of-B winding structures to achieve symmetric interwinding capacitive coupling from each terminal of one coil to another coil, and thus can achieve reduced electromagnetic interference (EMI) in isolation circuits for isolated power or data transfer applications.

As described above, isolation circuits may be used in some electrical systems for safety, noise immunity, and power or data communication between different domains (e.g., different power domains having large potential differences between the power domains) that may have different ground potentials. For example, sensitive control circuitry of an electric vehicle or robot may have a ground that is isolated from the ground of drive circuitry of the motors that may draw large DC currents and create noise and ground bounces. Some isolation circuits may implement galvanic isolation to break ground loops and prevent DC current flow from one domain to another, but may allow energy or information exchange between the different domains using capacitive, inductive, electromagnetic, optical, acoustic, or mechanical means.

For example, magnetic or electromagnetic coupling using transformers may be used in isolated DC-DC converter or other isolation circuits. In some examples, transformers may be implemented in package substrates or printed circuit boards (PCBs) for isolated power or data communication. The transformer may include a first planar transformer coil and a second planar transformer coil formed by metal wires in one or more metal layers and separated by non-magnetic (e.g., dielectric) laminate materials of the substrate that may provide both mechanical support and dielectric isolation.

One method of forming a planar transformer includes forming a coil with a spiral winding structure, where the coil may wind continuously inward from an outer terminal to an inner terminal (or outward from the inner terminal to the outer terminal). While straightforward to implement, spiral winding structures may suffer from asymmetrical capacitive coupling from each terminal of a first coil to a second coil. Specifically, the distributed interwinding capacitance seen from a first terminal (e.g., an outer terminal) of a coil may differ from the distributed interwinding capacitance seen from a second terminal (e.g., an inner terminal), because the different environments experienced by signals propagating in the coil on opposite paths from the two opposing terminals. As such, when a coil of the transformer is driven differentially, the differential signal applied to two terminals of the coil may have different capacitive coupling to another coil due to the asymmetric distributed interwinding capacitances. This asymmetric capacitive coupling may result in a non-zero net common-mode current being injected across the isolation barrier during differential excitation. The non-zero net common-mode current may return via the parasitic capacitor between the different ground planes (e.g., on the PCB or package substrate), creating a loop between the different ground planes that may have different potentials. This may form a path for common-mode noise to couple from a primary (e.g., noisy switching) side to a secondary (e.g., isolated) side, and cause conducted and radiated electromagnetic interference (EMI), which can cause isolated power converters and isolated data communication devices to fail EMI compliance standards such as CISPR 22/32 and FCC Part 15. EMI filters may be used in some systems to achieve regulatory compliance, but may significantly increase the overall system footprint, volume, and cost.

One technique to reduce the asymmetric interwinding capacitive coupling in planar transformers is using coils with a figure-of-8 winding structure, where each coil may include two halves: one half having a spiral winding structure that winds clockwise and the other half having a spiral winding structure that winds counterclockwise. When the two halves are symmetric, the capacitive coupling from each terminal of the two terminals of a coil to the other coil of the transformer may be matched, thereby substantially eliminating the net common-mode current injection that may otherwise be caused by asymmetric interwinding capacitive coupling. However, the figure-of-8 winding structure may have some drawbacks. For example, to achieve symmetry in a figure-of-8 winding structure, the terminal vias for connecting the terminals of the coil to contact pads on the substrate surface may be positioned at the geometric center of each half of the figure-of-8 winding structure. A lateral displacement of the terminal vias from the center may break the symmetry. The bond wires (or other bridge devices) used to connect the contact pads or vias of the terminals at the center of each spiral winding structure to an IC die isolated by the transformer may be long, which may result in increased parasitic inductance and resistance, complicate assembly, lower yield, and some asymmetry. In addition, in configurations where the primary-side and secondary-side IC dies are mounted on the same surface of the substrate, the terminal vias at the center of the figure-of-8 winding structure are surrounded on all sides by coil segments for an opposing voltage domain. Maintaining a lateral clearance for high-voltage isolation between the terminal vias and the surrounding coil segments for the opposing voltage domain may limit the number of turns that can be used and thus the achievable inductance and power density. Furthermore, flip-chip assembly may not be readily achievable with the figure-of-8 winding structure when the terminal vias are at the centers of the spiral winding structures.

Another symmetric coil winding structure is the figure-of-0 winding structure, in which a coil may cross over itself using wires or traces in additional metal layers to achieve symmetry. This technique may use more (e.g., four or more) metal layers, such as two metal layers for the coils and two metal layers for the crossover segments, which may increase the cost and manufacturing complexity.

According to some examples disclosed herein, integrated symmetric planar transformers may be implemented using two (or more) metal layers of a substrate. The symmetric planar transformers may include coils having figure-of-B winding structures to achieve symmetric interwinding capacitive coupling from each terminal of one coil to another coil, and thus may achieve reduced electromagnetic interference (EMI) in isolated power or data transfer applications. The figure-of-B winding structure also allows the terminal vias to be positioned away from the center of the winding structure to enable more turns in the windings, shorter bonding wires (or other bridge devices), flexible assembly configurations, and flip-chip (or face-to-face) connections between isolation circuits and semiconductor dies. In addition, the integrated symmetric planar transformers disclosed herein may be implemented using two metal layers in a package substrate, such that the complexity and cost of the package substrate and the packaged IC can be reduced.

In some examples, a packaged integrated circuit (IC) may include at least two semiconductor dies coupled together through an isolation circuit (e.g., a planar transformer) that may be integrated within a package substrate (e.g., a printed circuit board) having two or more metal layers. The integrated planar transformer may include two coils with symmetric distributed interwinding capacitance viewed from the two terminals of each coil along the coil in opposite directions, and the two coils can be formed in two metal layers of the package substrate. For example, a first coil of the two coils may be formed in a first metal layer, and a second coil of the two coils may be formed in a second metal layer. In some examples, each coil of the two coils may have a figure-of-B winding structure that includes two halves connected by a coil segment (e.g., a metal wore or trace) on the same side of the two halves, where each half of the two halves may have a spiral winding structure. Each terminal of the two terminals of a coil may be surrounded by the spiral winding structure of a respective half of the two halves. The two halves of each coil may have the same rotational winding direction (e.g., either clockwise or counterclockwise), and the two coils may have the same or opposite rotational winding direction. The two halves may be symmetrical with respect to a center axis. In some examples, the package substrate may include bridge structures (e.g., metal traces) on a different metal layer to couple the terminal vias of the coils to contact pads outside of the footprints of the coils, thereby enabling flip-chip interconnections with the semiconductor dies. In some examples, the two coils may be laterally offset from each other to enable flip-chip interconnections with the semiconductor dies, without using additional bridge structures.

In some examples, the semiconductor dies may include a first semiconductor die with a first power circuit and a second semiconductor die with a second power circuit. The first semiconductor die may be coupled to the second semiconductor die via the integrated planar transformer. The first power circuit may provide switching power signals to the integrated planar transformer. The second power circuit may receive, rectify, and regulate power signals transferred through the integrated planar transformer. In some examples, the first and second semiconductor dies and the integrated planar transformer may form a switching DC-DC converter. In some examples, the packaged IC may include a third semiconductor die that receives power from the second semiconductor die. In some examples, one or more of the semiconductor dies may include contact pads on bonding surfaces to enable flip-chip bonding with contact pads of the integrated planar transformer.

In some examples, each of the first and second semiconductor dies may also include circuits for data processing and transfer, and the first and second semiconductor dies may be coupled together through one or more isolated communication channels, such as one or more integrated planar transformers disclosed herein, for data transfer. In some examples, the packaged IC may also include separate (e.g., third and fourth) semiconductor dies that are coupled together through one or more isolated communication channels, such as one or more integrated planar transformers disclosed herein, for data transfer. The semiconductor dies and circuits for data processing and transfer may provide unidirectional or bidirectional signaling, for example, for functions such as telemetry, data signaling, buffering analog input signals for an analog-to-digital converter, buffering digital input signals for a digital-to-analog converter, and the like. The one or more integrated planar transformers for data transfer may have the same or similar winding structures as the integrated planar transformer for power transfer. In some examples, the one or more integrated planar transformers for data transfer may be outside of the footprint of the integrated planar transformer for power transfer. In some examples, one or more of the semiconductor dies for data transfer may include contact pads on bonding surfaces to enable flip-chip bonding with contact pads for one or more integrated planar transformers.

Various features are described hereinafter with reference to the figures. An illustrated example may not have all the aspects or advantages shown. An aspect or an advantage described in conjunction with a particular example is not necessarily limited to that example and can be practiced in any other examples even if not so illustrated or if not so explicitly described. Further, methods described herein may be described in a particular order of operations, but other methods according to other examples may be implemented in various other orders (e.g., including different serial or parallel performance of various operations) with more or fewer operations.

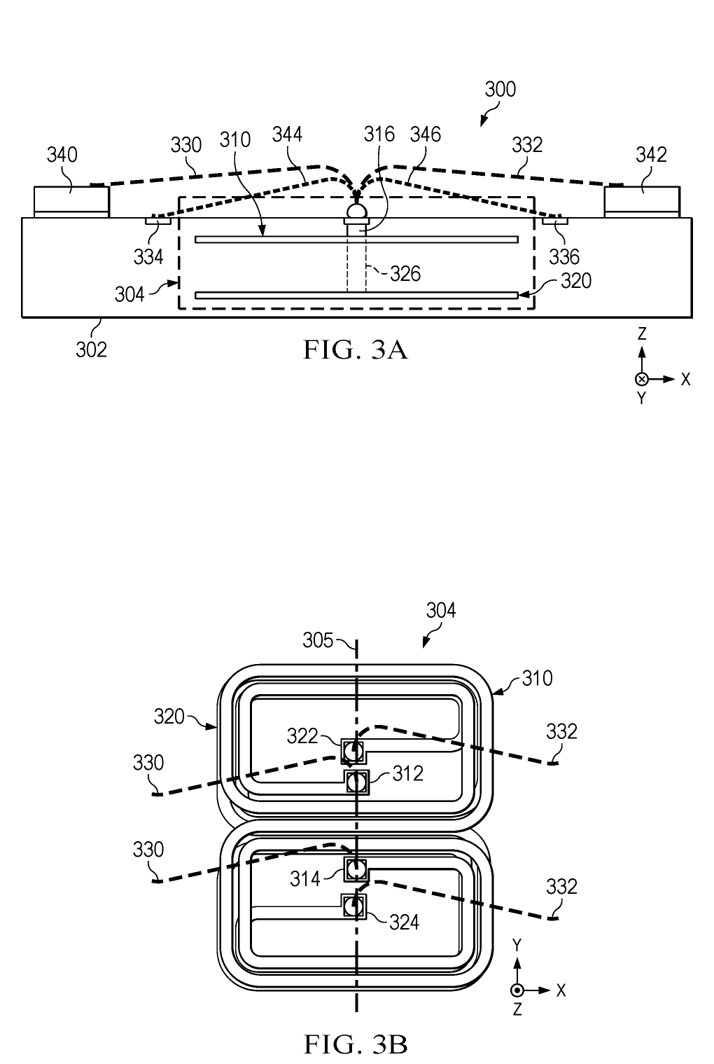

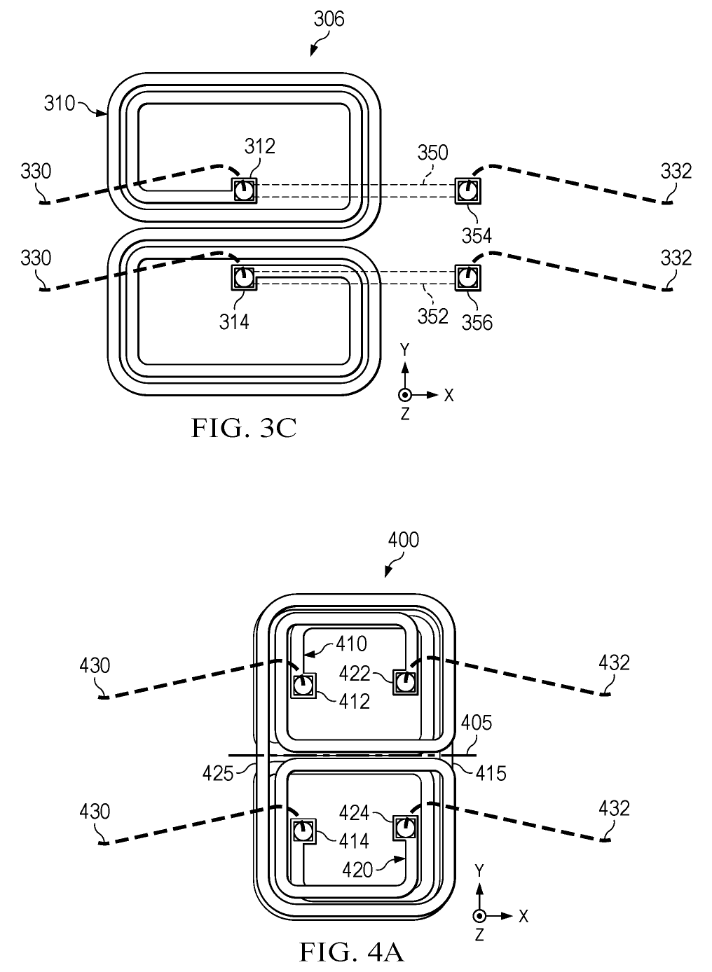

Various examples are described herein. Although the specific examples may illustrate various aspects of the above generally described features, examples may incorporate any combination of the above generally described features (which are described in more detail in examples below). Three-dimensional x-y-z axes are illustrated in some figures for ease of reference. Some cross-sectional views of various semiconductor devices herein may be general depictions to illustrate various aspects or concepts concerning such semiconductor devices. It is noted that, even though the coils in some examples may be shown to have slight lateral offset in the top views (e.g., FIGS. 3B-4C and 6) in order to show the coil at a lower layer, the coils can be aligned (without lateral offset) in some implementations.

In the following description, for the purposes of explanation, specific details are set forth in order to provide a thorough understanding of examples of the disclosure. However, it will be apparent that various examples may be practiced without these specific details. For example, devices, systems, structures, assemblies, integrated circuits, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Isolation circuits may be used in many electrical systems for safety, noise immunity, and power or data communication between different domains (e.g., different power domains having large potential differences) that may have different ground potentials. For example, an isolated voltage converter may convert an input direct current (DC) voltage to an output DC voltage at a different level using a transformer. The transformer may include two conductive windings (also referred to as coils or inductors), where a first winding coupled to a transmit side may be referred to as a “primary” winding, while a second winding couple to the receive side may be referred to as a “secondary” winding. The isolated voltage converter may be in a package and may include a transformer coupled to two semiconductor dies by bond wires. The first semiconductor die may include a circuit coupled to the primary winding of the transformer and may include, for example, a switching network to convert the DC input voltage to a switching waveform, in order to transfer energy from the primary winding to the secondary winding of the transformer. The second semiconductor die may be coupled to the secondary winding and may include, for example, a rectifier to convert the switching waveform from the secondary winding to a DC output voltage. The semiconductor dies may also be coupled to a leadframe by way of, for example, bond wires. The two semiconductor dies may be coupled to different ground planes on a package substrate or PCB, where the different ground planes may have different potentials during operation. Since the two semiconductor dies are coupled together through a transformer that does not provide a DC current path, a galvanic isolation may be formed between the two semiconductor dies, thereby allowing the two semiconductor dies to operate in separate power domains and reducing interference between the two semiconductor dies.

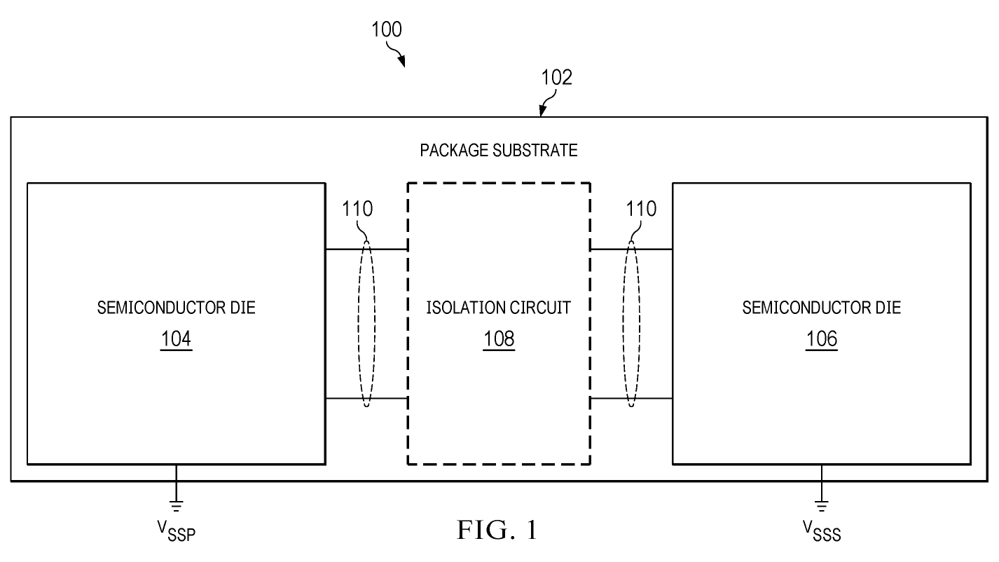

FIG. 1 is a block diagram of an example of a packaged IC 100 having an integrated isolation circuit 108. In the illustrated example, packaged IC 100 also includes a package substrate 102, a semiconductor die 104, and a semiconductor die 106. Semiconductor dies 104 and 106 may be mounted to package substrate 102, which can support semiconductor dies 104 and 106 as a circuit support structure. Package substrate 102 may include, for example, a lead frame, an interposer, or a printed circuit board that allows the mounting thereon of IC dies and is configured to provide electrical interconnectivity between the IC dies and one or more other circuits on or external to the package substrate. In some examples, package substrate 102 may include multiple ground planes that are separate from each other, such as a first (e.g., primary side) ground plane Vssp and a second (e.g., secondary side) ground plane Vsss.

In some examples, isolation circuit 108 may be integrated, formed, or embedded into a substrate that includes multiple dielectric layers and metal layers. In some examples, isolation circuit 108 may be integrated, formed, or embedded into package substrate 102, as indicated by the dashed lines in FIG. 1. Isolation circuit 108 may include contact pads or bonding pads formed thereon. Isolation circuit 108 may be coupled to semiconductor dies 104 and 106 through the contact pads and interconnects 110 (e.g., bond wires, bumps, pillars, or balls). In some examples, package substrate 102 may include contact pads formed thereon for connecting to semiconductor dies 104 and 106 and/or isolation circuit 108. In some examples, package substrate 102 may include metallic interconnects 110 to allow interconnectivity between semiconductor dies 104 and 106 and/or isolation circuit 108.

In some examples, isolation circuit 108 may provide a galvanic isolation barrier between two different power domains, such as power domains with different supply voltages, or analog and digital domains. The different power domains may have respective ground planes (e.g., Vssp and Vsss) that are isolated from each other. The galvanic isolation barrier formed by isolation circuit 108 may prevent direct current (DC) flow between semiconductor dies 104 and 106, while still allowing energy or signal transfer between semiconductor dies 104 and 106. For example, isolation circuit 108 may include one or more transformers for magnetic coupling, one or more capacitors for capacitive coupling, one or more optocouplers for optical coupling, or one or more acoustic transducers for acoustic coupling.

In one example, packaged IC 100 may be a DC-to-DC converter having a transformer as isolation circuit 108, semiconductor die 104 may include circuits such as a half-bridge circuit or a full-bridge circuit and a driver circuit, for providing a voltage (and a current) to the primary winding of the transformer. In one example, the voltage and the current may be from a power supply for a PCB on which package substrate 102 is mounted. Semiconductor die 106 may include a bridge circuit and a drive and regulation circuit for receiving a voltage (and a current) from the secondary winding of the transformer and providing one or more regulated output voltages and/or currents for use by a load on the PCB. The load may include, for example, an application-specific integrated circuit (ASIC), a field-programmable gate array (FPGA), a microcontroller, a processor, a drive circuit (e.g., for driving a motor), and the like. In some examples, semiconductor dies 104 and/or 106 may represent controller circuit, current and voltage sensors, gate drivers for insulated-gate bipolar transistors, gate drivers for field effect transistors (FETs), and the like.

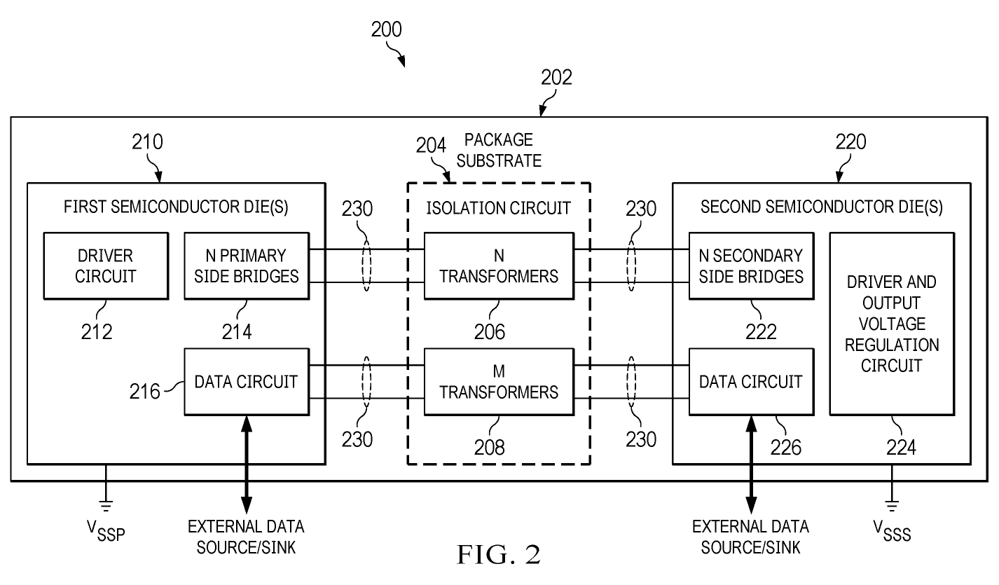

FIG. 2 is a block diagram of an example of a packaged IC 200 having an integrated isolation circuit 204 including inductive isolation channels coupled to two or more semiconductor dies, according to some examples. In the illustrated example, packaged IC 200 may also include a package substrate 202, one or more first semiconductor dies 210 (e.g., a primary side circuit), and one or more second semiconductor dies 220 (e.g., a secondary side circuit) that are coupled to the one or more first semiconductor dies 210 through integrated isolation circuit 204. First and second semiconductor dies 210 and 220 may be mounted on package substrate 202, and may be coupled to integrated isolation circuit 204 through interconnects 230 (e.g., bond wires, bumps, balls, or traces). Integrated isolation circuit 204 may be mounted on or formed in package substrate 202. Package substrate 202 may include, for example, a package lead frame, an interposer, or a printed circuit board. In some examples, package substrate 202 may include multiple ground planes that are separate from each other, such as a first (e.g., primary side) ground plane Vssp and a second (e.g., secondary side) ground plane Vsss. In some examples, package substrate 202 may include fiberglass-based materials that use etched metal (e.g., copper) layers and drilled vias instead of electroplated layers and vias. In some examples, package substrate 202 may include contact pads and/or interconnects 230 formed thereon to allow interconnectivity between first and second semiconductor dies 210 and 220 and integrated isolation circuit 204.

In some examples, integrated isolation circuit 204 may be formed in one or more metal layers of package substrate 202, as indicated by dashed lines. In some examples, integrated isolation circuit 204 may be formed in one or more metal layers of a substrate mounted on package substrate 202. In the illustrated example, integrated isolation circuit 204 may include N power transformers 206 and M data transformers 208. Each power transformer 206 may include two windings or coils (e.g., a primary winding and a secondary winding) implemented in two or more metal layers of package substrate 202 or a substrate (e.g., a PCB) mounted on package substrate 202. Each data transformer 208 may include two windings or coils (e.g., a primary winding and a secondary winding) implemented in two or more metal layers of package substrate 202 or a substrate (e.g., a PCB) mounted on package substrate 202. The size of each data transformer 208 may be smaller than the size of each power transformer 206. In some examples, one or more data transformers 208 may reside within a footprint of a power transformer 206 (e.g., within a footprint of the windings of a power transformer 206). In some examples, one or more data transformers 208 may be outside the footprint of a power transformer 206. Data transformer 208 may be used for bidirectional or unidirectional data transfer.

One or more first semiconductor dies 210 may be coupled to N primary windings of N power transformers 206, and may include a driver circuit 212, N primary side bridges 214, and a data circuit 216 (e.g., a digital circuit). N can be one or more. Each of the N primary side bridges 214 may be coupled to a primary winding of a respective one of N power transformers 206 by a respective interconnect 230 to provide a voltage to the power transformer 206. Data circuit 216 may be on the same semiconductor die or a separate semiconductor die from driver circuit 212 and primary side bridges 214. Any suitable circuit configuration may be used for driver circuit 212, primary side bridges 214, and data circuit 216.

One or more second semiconductor dies 220 may include N secondary side bridges 222 coupled to N secondary windings of N power transformers 206, a driver and output voltage regulation circuit 224, and a data circuit 226 (e.g., a digital circuit). Data circuit 226 may be on the same semiconductor die or a separate semiconductor die from driver and output voltage regulation circuit 224 and secondary side bridges 222. Any suitable circuit configuration may be used for secondary side bridges 222, driver and output voltage regulation circuit 224, and data circuit 226. Each of N secondary side bridges 222 is coupled to a secondary winding of a respective power transformer 206 by a respective interconnect 230. Driver and output voltage regulation circuit 224 may provide a control function to secondary side bridges 222. In some examples, semiconductor dies 220 may include another semiconductor die that receives power from driver and output voltage regulation circuit 224.

In one example, data circuit 216 may provide a first data signal to the primary winding of a data transformer 208 via interconnects 230, and data circuit 226 may receive the first data signal from the secondary winding of the data transformer 208 via interconnects 230. In some examples, data circuit 226 may provide a second data signal to the secondary winding of data transformer 208 via interconnects 230, and data circuit 216 may receive the second data signal from the primary winding and interconnects 230.

By integrating the semiconductor dies for power regulation and/or data transfer with the isolation circuits in the same package, overall size of the system may be reduced. Moreover, by placing the transformers of the isolation circuits in the package substrate, which can be much thicker than the transformer windings, the vertical separation between the transformer windings and the semiconductor die can be increased, at least compared with transformer windings (or other isolation circuits) formed in the metallization layer over a semiconductor die. Such arrangements can reduce the parasitic capacitance between the transformer windings and the semiconductor die, which can provide connection to ground. The reduced parasitic capacitance can improve the quality factor (QF) of the transformer. The increased vertical separation can also reduce the eddy current in the semiconductor die caused by the magnetic field generated by the transformer, which can reduce loss and further improve power transfer efficiency. Further, as explained below, the transformer can also provide improved common-mode transient immunity and improved matching for differential signals.

The flexibility in the routing capability of the package substrate can also improve the connectivity and signal integrity of the application specific IC serviced by the isolated power device (e.g., isolated DC-to-DC converter). Some examples of the packaged IC integrate power and bidirectional data communication with minimized/reduced crosstalk, so that they can operate independently, which makes the use of the isolated co-packaged device more flexible. In at least one example, the package substrate comprising two metal layers improves efficiency for power transformers using thicker metal (e.g., copper) traces. Since the semiconductor dies may be over the package substrate, the transformers in the package substrate may be at longer distances from the semiconductor dies, which can reduce the Eddy current loss in the semiconductor substrates induced by the transformers. Accordingly, compared with transformers that are integrated in the silicon metallization layers, transformers in the package substrate can have higher QFs. Embedding the data transformers in the substrate also allows for high frequency signal communication between data integrated circuits. Routing signal and power through a package substrate having two metal layers may reduce interconnect congestion on top of the substrate, which allows for smaller packaged integrated circuit as semiconductor dies in the packaged integrated circuit can be placed closer to one another.

One method of forming the transformers of isolation circuit 108 or 204 may include, for each coil or winding of a transformer, forming a spiral winding structure on a metal layer, where the coil may wind continuously inward from an outer terminal to an inner terminal (or outward from the inner terminal to the outer terminal). The two coils or windings of the transformer may be formed on two relatively tightly coupled metal layers, and thus the transformer may have high parasitic interwinding capacitance. While straightforward to implement, spiral winding structures may suffer from asymmetrical capacitive coupling from each terminal of a first coil to a second coil. Specifically, the distributed interwinding capacitance seen from a first terminal (e.g., an outer terminal) of a coil may differ from the distributed interwinding capacitance seen from a second terminal (e.g., an inner terminal), because the different environments experienced by signals propagating in the coil on opposite paths from the two opposing terminals.

In some applications, the primary side terminals can receive/transmit differential signals, and the secondary side terminals can also transmit/receive differential signals. Asymmetries in the transformer and in the semiconductor die inside the packaged IC may induce a current flowing through the parasitic capacitance of the transformer barrier and returning through the parasitic capacitance between the PCB ground planes, which may generate a voltage difference across the PCB ground planes and cause common-mode noise. The common-mode current may cause EMI. In addition, the voltages at the PCB ground planes can move with respect to each other with time, and the PCB may act as a dipole antenna radiating the electromagnetic waves caused by the time-varying voltage. The radiation can create disturbance to other devices on the PCB.

As such, when a coil of the transformer is driven differentially, the differential signal applied to two terminals of the coil may have different capacitive coupling to another coil due to the asymmetric distributed interwinding capacitances. This asymmetric capacitive coupling may result in a non-zero net common-mode current being injected across the isolation barrier during differential excitation. The non-zero net common-mode current may return via the parasitic capacitor between the different ground planes (e.g., on the PCB or package substrate), creating a loop between the different ground planes that may have different potentials. This may form a path for common-mode noise to couple from a primary (e.g., noisy switching) side to a secondary (e.g., isolated) side, and cause conducted and radiated electromagnetic interference (EMI), which can cause isolated power converters and isolated data communication devices to fail EMI compliance standards such as CISPR 22/32 and FCC Part 15. EMI filters may be used in some systems to achieve regulatory compliance, but may significantly increase the overall system footprint, volume, and cost.

One technique to reduce the asymmetric interwinding capacitive coupling in planar transformers is using coils with a figure-of-8 winding structure, where each coil may include two halves: one half having a spiral winding structure that winds clockwise and the other half having a spiral winding structure that winds counterclockwise. When the two halves are symmetric, the capacitive coupling from each terminal of the two terminals of a coil to the other coil of the transformer may be matched, thereby substantially eliminating the net common-mode current injection that may otherwise be caused by asymmetric interwinding capacitive coupling. However, the figure-of-8 winding structure may have some drawbacks. For example, to achieve symmetry in a figure-of-8 winding structure, the terminal vias for connecting the terminals of the coil to contact pads on the substrate surface may be positioned at the geometric center of each half of the figure-of-8 winding structure. A lateral displacement of the terminal vias from the center may break the symmetry. The bond wires (or other bridge devices) used to connect the contact pads or vias of the terminals at the center of each spiral winding structure to an IC die isolated by the transformer may be long, which may result in increased parasitic inductance and resistance, complicate assembly, lower yield, and some asymmetry. In addition, in configurations where the primary-side and secondary-side IC dies are mounted on the same surface of the substrate, the terminal vias at the center of the figure-of-8 winding structure are surrounded on all sides by coil segments for an opposing voltage domain. Maintaining a lateral clearance for high-voltage isolation between the terminal vias and the surrounding coil segments for the opposing voltage domain may limit the number of turns that can be used and thus the achievable inductance and power density. Furthermore, flip-chip assembly may not be readily achievable with the figure-of-8 winding structure when the terminal vias are at the centers of the spiral winding structures.

FIG. 3A is a cross-sectional view of an example of a device 300 including an isolation circuit that includes a planar transformer 304 having two coils with figure-of-8 winding structures. Device 300 may include a substrate 302 and semiconductor dies 340 and 342 mounted on substrate 302. Substrate 302 may be a package substrate or another substrate (e.g., a PCB) including multiple dielectric layers and metal layers. In the illustrated example, substrate 302 may include two metal layers, and planar transformer 304 may be formed using the two metal layers. Planar transformer 304 may include a first coil 310 formed in one metal layer in substrate 302, and a second coil 320 formed in another metal layer in substrate 302. The two metal layers may be separated by one or more dielectric layers that provide a high-voltage isolation barrier. Terminals of first coil 310 may be coupled to contact pads on a surface of substrate 302 through vias 316, and the contact pads may be coupled to semiconductor die 340 through bond wires 330. Terminals of second coil 320 may be coupled to contact pads on the surface of substrate 302 through vias 326, and the contact pads may be coupled to semiconductor die 342 through bond wires 332.

In some examples, the surface of substrate 302 may include contact pads 334 and 336, and the contact pads coupled to the terminals of first coils 310 and second coil 320 may be coupled to contact pads 334 and 336 by bond wires 344 and 346, respectively, and contact pads 334 and 336 may be coupled to semiconductor dies 340 and 342, respectively, using metal traces on the surface of substrate 302 or on the metal layers of substrate 302. Even though not shown in FIG. 3A, device 300 may include molding compound encapsulating semiconductor dies 340 and 342 and at least a portion (e.g., a top portion) of substrate 302.

FIG. 3B is a top view of an example of planar transformer 304 in device 300 of FIG. 3A. As described above, planar transformer 304 may include first coil 310 and second coil 320. In the illustrated example, first coil 310 may include a figure-of-8 winding structure formed by metal traces on a metal layer, and may include a first portion (e.g., an upper portion in the y direction) and a second portion (e.g., a lower portion in the y direction). Each of the first portion and the second portion of first coil 310 may have a spiral winding structure. The first portion may wind clockwise from a first terminal 312, and the second portion may wind counterclockwise towards a second terminal 314. First terminal 312 and second terminal 314 may be coupled to the surface of substrate 302 by vias 316. The winding structure of second coil 320 may be a substantially mirrored version of the winding structure of first coil 310, and may include a first terminal 322 and a second terminal 324. First terminal 322 and second terminal 324 may be coupled to pads on the surface of substrate 302 by vias 326.

As shown in FIG. 3B, in order to achieve symmetrical capacitive coupling from terminals of first coil 310 or second coil 320 to the other coil of the transformer, both first terminal 312 and second terminal 314 are on a center line 305 of planar transformer 304, and both first terminal 322 and second terminal 324 are on center line 305 of planar transformer 304. A lateral displacement of the terminals and vias from center line 305 may break the symmetry. The bond wires 330 and 332 (or other bridge devices) used to connect the contact pads or the vias for the terminals at the center of planar transformer 304 to semiconductor dies 340 and 342 may be long, resulting in increased parasitic inductance and resistance, complicate assembly, and some additional asymmetry. For example, as shown in FIG. 3B, the first portion (e.g., upper portion) of first coil 310 may wind clockwise from first terminal 312, but bond wire 330 coupled to the via or contact pad for first terminal 312 may have at least a portion that winds in the opposite direction from the spiral winding of the first portion. In contrast, the second portion(e.g., lower portion) of first coil 310 may wind counterclockwise towards second terminal 314, and bond wire 330 coupled to the via or contact pad for second terminal 314 may continue the winding in the counterclockwise direction. Thus, the symmetry between first terminal 312 and second terminal 314 may be broken by bond wires 330.

In addition, in configurations where semiconductor dies 340 and 342 are mounted on the same surface of substrate 302, the via for a terminal at the center of a coil may be surrounded on all sides by coil segments of another coil for another voltage domain. Maintaining a lateral clearance for high-voltage isolation between the terminal vias and the surrounding coil segments for the opposing voltage domain may limit the number of turns that can be used and thus the achievable inductance and power density. Furthermore, flip-chip assembly may not be readily achievable with the figure-of-8 winding structure when the vias and the corresponding contact pads are on center line 305 of the coil. In order to include more turns in each coil and enable flip-chip assembly, more metal layers may be used in substrate 302.

FIG. 3C is a top view of another example of a planar transformer 306 of an isolation circuit that may be used in device 300. FIG. 3C shows the winding structure of first coil 310. Second coil 320 may have a similar winding structure, such as a same or mirrored version of the winding structure of first coil 310. As described above, first coil 310 may be formed in a first metal layer closer to a first surface (e.g., the upper surface) of substrate 302, and terminals 312 and 314 of first coil 310 may be coupled through vias 316 to contract pads on the upper surface of substrate 302. Bond wires 330 may be connected to the contact pads and bonding pads on semiconductor die 340. Second coil 320 may be formed in a second metal layer further away from the first surface but closer to an opposing surface (e.g., the lower surface) of substrate 302, and terminals 322 and 324 of second coil 320 may be coupled through vias to metal traces 350 and 352 on a third metal layer of substrate 302. In some examples, the third metal layer may be close to the lower surface of substrate 302. Vias 354 and 356 may be coupled to metal traces 350 and 352 and contact pads on the upper or lower surface of substrate 302. Bond wires 332 may be connected to the contact pads and semiconductor die 342. In some examples, bond wires 332 may not be used, and semiconductor die 342 may be coupled to the contact pads on vias 354 and 356 through flip-chip assembly.

In addition to enabling flip-chip assembly, planar transformer 306 may allow more turns in the spiral winding structure because the vias for the terminals may not be surrounded by coil segments for another power domain. However, more than two metal layers may be used for planar transformer 306, and the vias coupled to the terminals of first coil 310 and second coil 320 may be on center line 305 to maintain the symmetry.

According to some examples disclosed herein, integrated symmetric planar transformers may be implemented using two (or more) metal layers of a substrate. The symmetric planar transformers may include coils having figure-of-B winding structures to achieve symmetric interwinding capacitive coupling from each terminal of one coil to another coil, and thus may achieve reduced electromagnetic interference (EMI) in isolated power or data transfer applications. Each coil may be formed in a respective metal layer, and thus the planar transformer can be formed using two metal layers, such that the complexity and cost of the package substrate and the packaged IC can be reduced. The figure-of-B winding structure of each coil includes two halves connected by a trace on the same side of the two halves. Each half of the two halves has a spiral winding structure with a terminal inside of the spiral winding structure. The two halves may be symmetrical with respect to a center axis. The two halves in each coil may have the same rotational winding direction (e.g., either clockwise or counterclockwise), and the two coils may have the same or opposite winding directions. The terminals of each coil and the vias for connecting the terminals to a surface of the substrate may be positioned anywhere inside the spiral winding structure (e.g., away from the center and near an edge region), and the two coils may be laterally displaced with respect to each other, without degrading the symmetry of the coils. As a result, the bridge devices (e.g., bond wires) connecting the vias or pads for the terminals to the semiconductor dies can be made significantly shorter. The figure-of-B winding structure may also allow more turns in each spiral winding, flexible assembly configurations, and flip-chip (or face-to-face) connections between isolation circuits and semiconductor dies. Due to the symmetrical structure of the transformer, capacitive coupling through the transformer may cause substantially zero net common-mode charge injection across the isolation barrier during differential excitation, and thus the conducted and radiated EMI may be reduced.

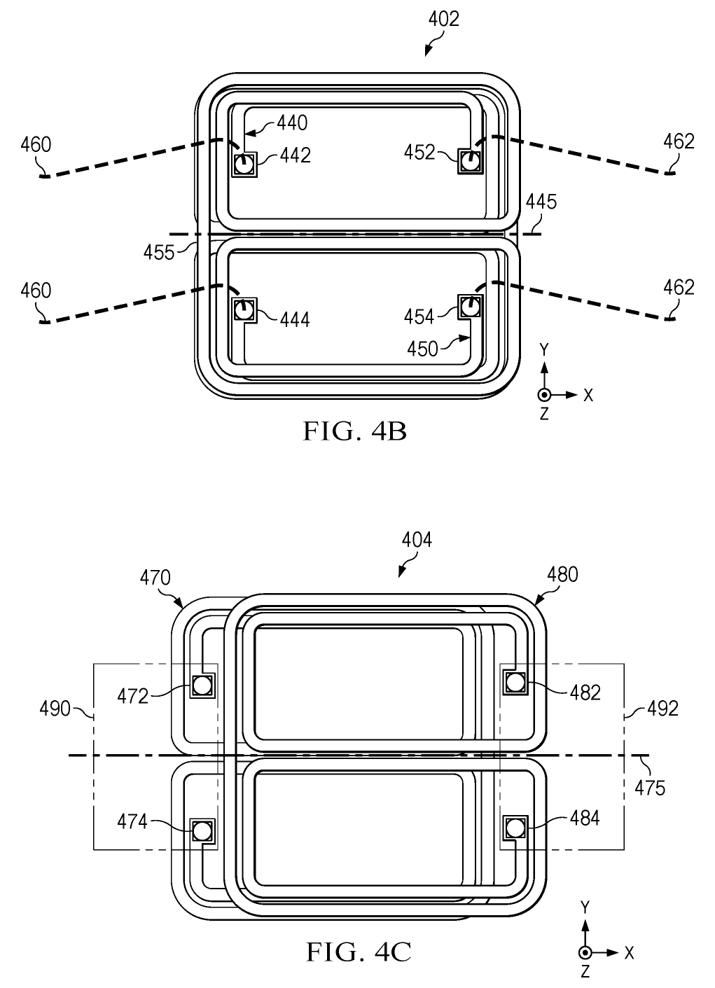

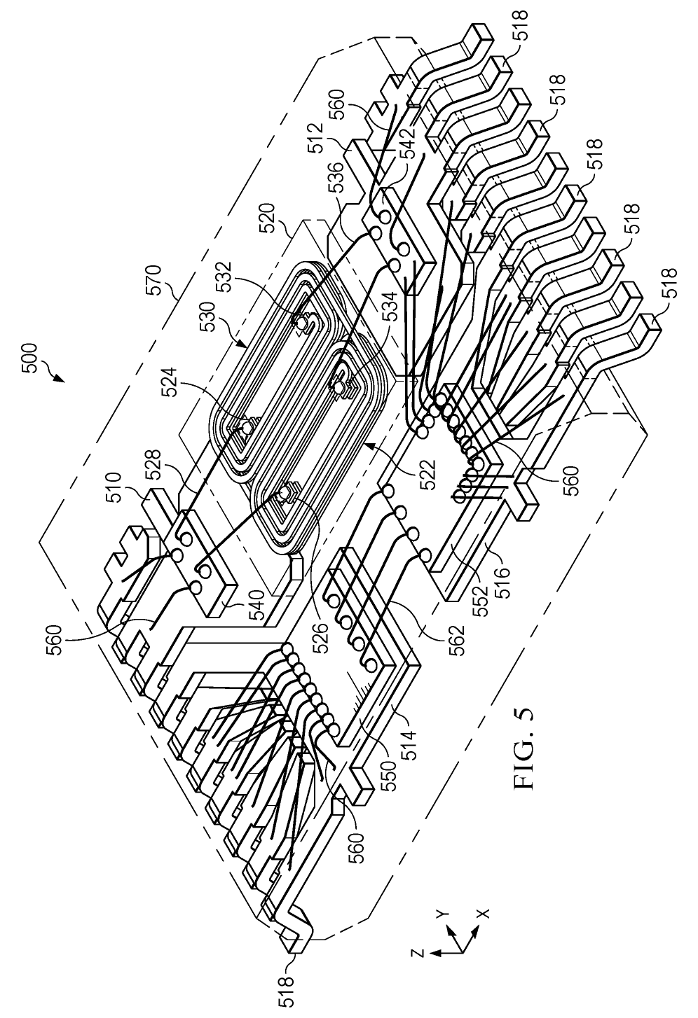

FIG. 4A is a top view of an example of a planar transformer 400 including two coils each having a figure-of-B winding structure, according to some examples. Planar transformer 400 may be used in the isolation circuits of packaged IC 100 or 200 described above. In the illustrated example, planar transformer 400 includes a first coil 410 and a second coil 420. First coil 410 may be formed in a first metal layer of a substrate, and second coil 420 may be formed in a second metal layer of the substrate. In some examples, second coil 420 may be substantially a mirrored version of first coil 410. First coil 410 may include two halves that are symmetric with respect to a center line 405 (which may be referred to as reflection symmetry, mirror symmetry, or line symmetry). The two halves are connected by a coil segment 415 that is on the same side of the two halves. Each half of first coil 410 may have a spiral winding structure in a substantially square region. A first half of first coil 410 may wind clockwise from a first terminal 412. A second half of first coil 410 may also wind clockwise towards a second terminal 414. First terminal 412 and second terminal 414 may be coupled to contact pads on a surface of the substrate by vias. In the illustrated example, first terminal 412, second terminal 414, and the corresponding vias may be offset from the center of first coil 410 in the x direction. Since the terminals of first coil 410 may be offset from the center of first coil 410 in the x direction, bond wires 430 for connecting the terminals of first coil 410 to a semiconductor die may be shorter than bond wires 330 of FIGS. 3A-3C.

Similarly, second coil 420 may include two halves that are symmetric with respect to center line 405 and are connected by a coil segment 425. Each half of second coil 420 may have a spiral winding structure in a substantially square region. A first half of second coil 420 may wind counterclockwise from a first terminal 422. A second half of second coil 420 may also wind counterclockwise towards a second terminal 424. First terminal 422 and second terminal 424 may be coupled to contact pads on a surface of the substrate by vias. In the illustrated example, first terminal 422, second terminal 424, and the corresponding vias may be offset from the center of second coil 420 in the x direction. Since the terminals of second coil 420 may be offset from the center of second coil 420 in the x direction, bond wires 432 for connecting the terminals of second coil 420 to a semiconductor die may be shorter than bond wires 332 of FIGS. 3A-3C.

The reflection symmetry of each coil can improve the matching between the differential signals at the primary side terminals (and transmitted/received via the primary winding), and the matching between the differential signals at the secondary side terminals (and transmitted/received via the secondary winding). For example, because the two halves of a figure-of-B coil wind in the same rotational direction and are reflection-symmetric with respect to each other, the parasitic capacitance between the first terminal of the coil and a second coil may be the same as the parasitic capacitance between the second terminal of the coil and the second coil. Therefore, when the coil with a figure-of-B winding structure is differentially excited, the capacitive displacement currents across the isolation barrier from the two terminals may be equal and opposite, resulting in substantially zero net common-mode current injection. This substantially eliminates the EMI-generating loop current. As such, the improved matching can reduce the net current flowing through the interwinding capacitance, improve immunity to common-mode noise, and reduce the voltage difference across the PCB ground planes, hence reducing the EMI caused by the common-mode current. The symmetry can also reduce EMI radiation from the packaged IC caused by the antenna created between primary and secondary ground planes of the PCB on which the IC dies and the isolation circuit are mounted.

An advantage of the figure-of-B winding structure over the figure-of-8 winding structure is that the symmetry of the figure-of-B coil is invariant to lateral displacement of the terminals and vias along a direction (e.g., the x-axis in FIG. 4A) towards the corresponding semiconductor die. Thus, shifting the terminals and vias away from the center in the x direction would not degrade the symmetry of the coil or increase the net common-mode current injection, because the two halves of a coil with the figure-of-B winding structure remain mirror images of each other regardless of the lateral position of the coil. This is not the case for coils with the figure-of-8 winding structure, in which lateral displacement of the terminals and vias from the center may break the symmetry.

FIG. 4B is a top view of another example of a planar transformer 402 including two coils each having a figure-of-B winding structure, according to some examples. In the illustrated example, planar transformer 402 includes a first coil 440 and a second coil 450. First coil 440 may be formed on a first metal layer of a substrate, and second coil 450 may be formed on a second metal layer of the substrate. In some examples, the first metal layer may be a layer lower than the second metal layer. First coil 440 may include a first terminal 442 and a second terminal 444, and is not fully shown in the top view in FIG. 4B. First terminal 442 and second terminal 444 may be coupled to a first semiconductor die through vias and bond wires 460. First coil 440 may have a winding structure similar to the winding structure of first coil 410 of FIG. 4A, but each half of the two halves of first coil 440 may have a substantially rectangular (rather than square) footprint.

In some examples, second coil 450 may be substantially a mirrored version of first coil 440. As shown in FIG. 4B, second coil 450 may include two halves that are symmetric with respect to a center line 445 and are connected by a coil segment 455. Each half of second coil 450 may have a spiral winding structure in a substantially rectangular region. A first half of second coil 450 may wind counterclockwise from a first terminal 452. A second half of second coil 450 may also wind counterclockwise towards a second terminal 454. First terminal 452 and second terminal 454 may be coupled to contact pads on a surface of the substrate by vias. In the illustrated example, first terminal 452, second terminal 454, and the corresponding vias may be offset from the center of second coil 450 in the x direction. Since the terminals of second coil 450 may be offset from the center of second coil 450 in the x direction, bond wires 462 for connecting the terminals of second coil 450 to a second semiconductor die may be shorter than bond wires 332 of FIGS. 3A-3C.

In FIG. 4B, the terminals and vias for the first and second coils are laterally displaced from the center in the x direction towards the respective semiconductor dies. This lateral displacement does not affect the symmetry of the figure-of-B coil, and can reduce the length of the bond wires or bridge devices. The shorter bond wires may have lower parasitic inductance and resistance, and thus may improve the power efficiency of the transformer and improve the assembly yield.

In some examples, the contact pads for the terminals of one coil may be on a first surface of the substrate and the contact pads for the terminals of another coil of the transformer may be on an opposing second surface of the substrate, the first semiconductor die may be mounted on the first surface of the substrate, and the second semiconductor die may be mounted on the second surface. In some examples, the contact pads for the terminals of the two coils of the transformer may be on the same surface of the substrate, and the two semiconductor dies may be mounted on the same surface of the substrate. In some examples where the contact pads and the corresponding semiconductor die are on a same surface of the substrate, the two coils of the transformer may be laterally shifted, such that the terminals and vias of one coil may be outside of the footprint of the other coil to enable flip-chip interconnects between the semiconductor die and the contact pads for the coil. As described above, the symmetry of the coil with figure-of-B winding structure is invariant to lateral displacement of the terminals and vias along a direction (e.g., the x-axis in FIG. 4A) towards the corresponding semiconductor die. The displacement between the two coils to enable flip-chip assembly would not break the symmetry of the parasitic interwinding capacitance and thus would not increase EMI that may otherwise be caused by non-zero net common-mode current injection due to unbalanced parasitic capacitive coupling through the transformer.

FIG. 4C is a top view of an example of a planar transformer 404 including two laterally offset coils each having a figure-of-B winding structure, according to some examples. In the illustrated example, planar transformer 404 includes a first coil 470 and a second coil 480. First coil 470 may be formed using a first metal layer of a substrate, and second coil 480 may be formed using a second metal layer of the substrate. Second coil 480 may be substantially a mirrored version of first coil 470. First coil 470 may include two halves that are symmetric with respect to a center line 405 and are connected together by a coil segment. Each half of first coil 470 may have a spiral winding structure in a substantially rectangular region. A first half of first coil 470 may wind clockwise from a first terminal 472. A second half of first coil 470 may also wind clockwise towards a second terminal 474. First terminal 472 and second terminal 474 may be coupled to contact pads on a surface of the substrate by vias. In the illustrated example, first terminal 472, second terminal 474, and the corresponding vias may be offset from the center of first coil 470 in the x direction.

Similarly, second coil 480 may include two halves that are symmetric with respect to center line 475 and are connected together by a coil segment. Each half of second coil 480 may have a spiral winding structure in a substantially rectangular region. A first half of second coil 480 may wind counterclockwise from a first terminal 482. A second half of second coil 480 may also wind counterclockwise towards a second terminal 484. First terminal 482 and second terminal 484 may be coupled to contact pads on a surface of the substrate by vias. In the illustrated example, first terminal 482, second terminal 484, and the corresponding vias may be offset from the center of second coil 480 in the x direction.

First coil 470 may be laterally offset from second coil 480 in the x direction, such that the terminals and vias (and the corresponding contact pads) of first coil 470 may be outside of the footprint of second coil 480, and the terminals and vias (and the corresponding contact pads) of second coil 480 may be outside of the footprint of first coil 470. Therefore, a first semiconductor die 490 can overlap the terminals and vias of first coil 470, and can have no overlap with second coil 480. Similarly, a second semiconductor die 492 can overlap the terminals and vias of second coil 480, and can have no overlap with first coil 470. In this configuration, first semiconductor die 490 and second semiconductor die 492 can be coupled to the contact pads for the terminals using flip-chip interconnects such as copper pillars, bumps, or balls, rather than bond wires (e.g., bond wires 430, 432, 460, and 462) that may have larger parasitic inductance and impedance.

According to some examples, a packaged integrated circuit (IC) may include at least two semiconductor dies coupled together through an isolation circuit (e.g., a planar transformer) that may be integrated within a package substrate (e.g., a printed circuit board) having two or more metal layers. The integrated planar transformer may include two coils with symmetric distributed interwinding capacitance viewed from the two terminals of each coil along the coil in opposite directions, and the two coils can be formed in two metal layers of the package substrate. For example, a first coil of the two coils may be formed in a first metal layer, and a second coil of the two coils may be formed in a second metal layer. In some examples, each coil of the two coils may have a figure-of-B winding structure that includes two halves connected by a coil segment (e.g., a metal wore or trace) on the same side of the two halves, where each half of the two halves may have a spiral winding structure. Each terminal of the two terminals of a coil may be surrounded by the spiral winding structure of a respective half of the two halves. The two halves of each coil may have the same rotational winding direction (e.g., either clockwise or counterclockwise), and the two coils may have the same or opposite rotational winding direction. The two halves may be symmetrical with respect to a center axis. In some examples, the package substrate may include bridge structures (e.g., metal traces) on a different metal layer to couple the terminal vias of the coils to contact pads outside of the footprints of the coils, thereby enabling flip-chip interconnections with the semiconductor dies. In some examples, the two coils may be laterally offset from each other to enable flip-chip interconnections with the semiconductor dies, without using additional bridge structures.

The semiconductor dies may include a first semiconductor die with a first power circuit and a second semiconductor die with a second power circuit. The first semiconductor die may be coupled to the second semiconductor die via the integrated planar transformer. The first power circuit may provide switching power signals to the integrated planar transformer. The second power circuit may receive, rectify, and regulate power signals transferred through the integrated planar transformer. In some examples, the first and second semiconductor dies and the integrated planar transformer may form a switching DC-DC converter. In some examples, the packaged IC may include a third semiconductor die that receives power from the second semiconductor die. In some examples, one or more of the semiconductor dies may include contact pads on bonding surfaces to enable flip-chip bonding with contact pads of the integrated planar transformer.

In some examples, each of the first and second semiconductor dies may also include circuits for data processing and transfer, and the first and second semiconductor dies may be coupled together through one or more isolated communication channels, such as one or more integrated planar transformers disclosed herein, for data transfer. In some examples, the packaged IC may also include separate (e.g., third and fourth) semiconductor dies that are coupled together through one or more isolated communication channels, such as one or more integrated planar transformers disclosed herein, for data transfer. The semiconductor dies and circuits for data processing and transfer may provide unidirectional or bidirectional signaling, for example, for functions such as telemetry, data signaling, buffering analog input signals for an analog-to-digital converter, buffering digital input signals for a digital-to-analog converter, and the like. The one or more integrated planar transformers for data transfer may have the same or similar winding structures as the integrated planar transformer for power transfer. In some examples, the one or more integrated planar transformers for data transfer may be outside of the footprint of the integrated planar transformer for power transfer. In some examples, one or more of the semiconductor dies for data transfer may include contact pads on bonding surfaces to enable flip-chip bonding with contact pads for one or more integrated planar transformers.

FIG. 5 is a perspective view of an example of a packaged device 500 including an isolation circuit 520 that includes a planar transformer having two coils with figure-of-B winding structures, according to some examples. Packaged device 500 may be an example of packaged IC 100 or 200 described above. In the illustrated example, packaged device 500 may include a lead frame or a package substrate that includes a first section 510, a second section 512, a third section 514, a fourth section 516, and a plurality of leads 518 (e.g., pins). Sections 510, 512, 514, and 516 may correspond to different power domains and may have respective ground planes that are isolated from each other by dielectric materials. Isolation circuit 520 may be mounted on the lead frame or package substrate, and may include a substrate and a planar transformer formed in or on the substrate. Packaged device 500 may also include a first semiconductor die 540 mounted on first section 510, a second semiconductor die 542 mounted on second section 512, a third semiconductor die 550 mounted on third section 514, and a fourth semiconductor die 552 mounted on fourth section 516. The semiconductor dies may be coupled to the corresponding sections of package substrate by bond wires 560. Packaged device 500 may include a molding compound 570 that encapsulates isolation circuit 520, sections 510-816, semiconductor dies 540, 542, 550, and 552, and portions of the plurality of leads 518.

The planar transformer of isolation circuit 520 may be similar to planar transformer 402 shown in FIG. 4B, and may include a first coil 522 and a second coil 530. Each of first coil 522 and second coil 530 may be formed on a respective metal layer in the substrate of isolation circuit 520 and may have a figure-of-B winding structure as described above with respect to, for example, FIGS. 4A-4C. Each half of the two mirror-symmetric halves of first coil 522 or second coil 530 may have a spiral winding structure in a rectangular region. First coil 522 may include a first terminal 524 and a second terminal 526 that are near an edge of the rectangular region and thus are close to first semiconductor die 540. First terminal 524 and second terminal 526 may be coupled to first semiconductor die 540 by bond wires 528. Second coil 530 may include a first terminal 532 and a second terminal 534 that are at an edge of the rectangular region and thus are close to second semiconductor die 542. First terminal 532 and second terminal 534 may be coupled to second semiconductor die 542 by bond wires 536.

In one example, first semiconductor die 540, isolation circuit 520, and second semiconductor die 542 may form an isolated power converter as described above with respect to, for example, FIGS. 1 and 2. For example, first semiconductor die 540 may include the primary side driver circuit (e.g., including a half-bridge circuit or a full-bridge circuit and a driver circuit), and second semiconductor die 542 may include the secondary side circuit (e.g., including a bridge or rectifier circuit and a driver and regulation circuit). As described above, due to the symmetric winding structure of each figure-of-B coil of the planar transformer, there may be no net common-mode current rejection caused by capacitive coupling through the planar transformer, and the terminals of the coils can be closer to the corresponding semiconductor die to reduce the length (and parasitic inductance) of bond wires 528 and 536.

In some examples, third semiconductor die 550 and fourth semiconductor die 552 may include data circuits as described above with respect to, for example, FIG. 2. Outputs from third semiconductor die 550 may be sent to fourth semiconductor die 552 through bond wires 562. In one example, third semiconductor die 550 may include at least a portion of an analog-to-digital converter (e.g., including a delta-sigma modulator), and fourth semiconductor die 552 may include digital data processing circuits and may be powered by the power output by second semiconductor die 542.

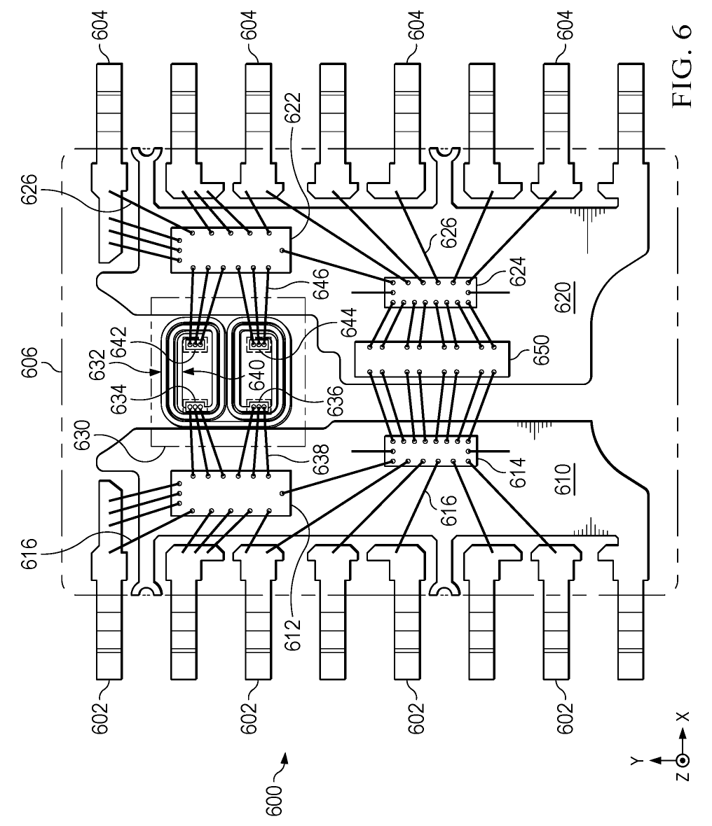

FIG. 6 is a top view of another example of a packaged device 600 including an isolation circuit 630 that includes a planar transformer having two coils with a figure-of-B winding structures, according to some examples. Packaged device 600 may be an example of packaged IC 200 of FIG. 2. Packaged device 600 may include a lead frame or a package substrate that includes a first section 610, a second section 620, and a plurality of leads 602 and 604 (e.g., pins). Sections 610 and 620 may correspond to different power domains and may have respective ground planes that are isolated from each other by dielectric materials. Isolation circuit 630 may be mounted on the lead frame or package substrate, and may include a substrate and a planar transformer formed in or on the substrate. Packaged device 600 may also include a first semiconductor die 612 mounted on first section 610, a second semiconductor die 622 mounted on second section 620, a third semiconductor die 614 mounted on first section 610, and a fourth semiconductor die 624 mounted on second section 620. Packaged device 600 may further include an isolation device 650 that may be used for isolated data transfer. The semiconductor dies may be coupled to the corresponding sections of package substrate by bond wires 616 or 626. Packaged device 600 may include a molding compound 606 that encapsulates isolation circuit 630, isolation device 650, sections 610 and 620, semiconductor dies 612, 614, 622, and 624, and at least portions of leads 602 and 604.

The planar transformer of isolation circuit 630 may be similar to planar transformer 402 shown in FIG. 4B or the planar transformer shown in FIG. 5, and may include a first coil 632 and a second coil 640. Each of first coil 632 and second coil 640 may be formed on a respective metal layer in the substrate of isolation circuit 630 and may have a figure-of-B winding structure as described above with respect to, for example, FIGS. 4A-4C. Each half of the two mirror-symmetric halves of first coil 632 or second coil 640 may have a spiral winding structure in a rectangular region. First coil 632 may include a first terminal 634 and a second terminal 636 that are at a side of the rectangular region that is closer to first semiconductor die 612. First terminal 634 and second terminal 636 may be coupled to first semiconductor die 612 by bond wires 638. Second coil 640 may include a first terminal 642 and a second terminal 644 that are at a side of the rectangular region that is closer to second semiconductor die 622. First terminal 642 and second terminal 644 may be coupled to second semiconductor die 622 by bond wires 646.

In one example, first semiconductor die 612, isolation circuit 630, and second semiconductor die 622 may form an isolated power converter as described above with respect to, for example, FIGS. 1 and 2. For example, first semiconductor die 612 may include the primary side driver circuit (e.g., including a half-bridge circuit or a full-bridge circuit and a driver circuit), and second semiconductor die 622 may include the secondary side circuit (e.g., including a bridge or rectifier circuit and a driver and regulation circuit). As described above, due to the symmetric winding structure of each figure-of-B coil of the planar transformer, there may be no net common-mode current rejection caused by capacitive coupling through the planar transformer, and the terminals of the coils can be closer to the corresponding semiconductor die to reduce the length (and parasitic inductance) of bond wires 638 and 646.

Third semiconductor die 614 and fourth semiconductor 624 may include data circuits. In some examples, third semiconductor die 614 may share a common ground plane (e.g., a primary side ground plane) with first semiconductor die 612. Fourth semiconductor die 624 may share a common ground plane (e.g., a secondary side ground plane) with second semiconductor die 622 and may receive power from second semiconductor die 622. Outputs from third semiconductor die 614 may be sent to fourth semiconductor die 624 through isolation device 650. In one example, isolation device 650 may include one or more planar transformers for isolated data transfer. The one or more planar transformers for isolated data transfer may have a figure-of-8, figure-of-B, figure-of-0, or another winding structure. In the illustrated example, isolation device 650 may include four planar transformers for four isolated data channels. In another example, isolation device 650 may include one or more capacitors, optical transceivers, or acoustic transceivers for isolated data transfer.

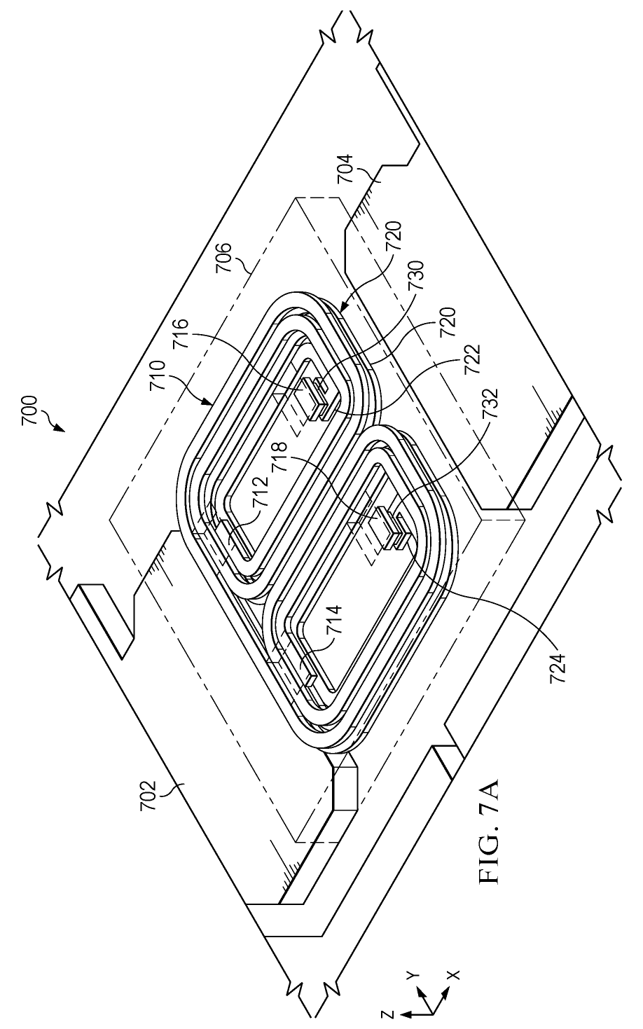

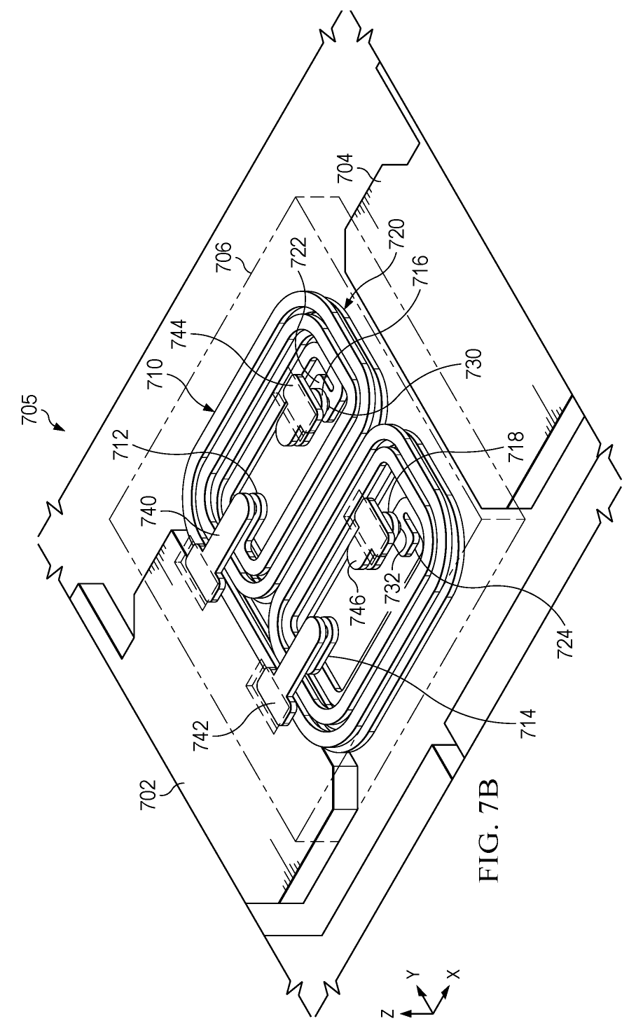

FIG. 7A is a perspective view of an example of an isolation circuit 700 that includes a planar transformer having two coils with figure-of-B winding structures formed in two metal layers, according to some examples. Isolation circuit 700 may include a package substrate (e.g., a lead frame or a PCB) having a first section 702 and a second section 704 that are separated by a dielectric barrier. First section 702 and second section 704 may be for different power domains, where the ground plane for first section 702 may be isolated from the ground plane for second section 704 by the dielectric barrier. Isolation circuit 700 may include a substrate 706 mounted on the package substrate, where substrate 706 may include a planar transformer formed therein to provide a galvanic isolation between first section 702 and second section 704.

In the illustrated example, substrate 706 may include a first metal layer and a second metal layer separated by one or more dielectric layers. A first coil 710 may be formed in the first metal layer, and may have a figure-of-B winding structure as described above. First coil 710 may include a first half having a spiral structure that winds counterclockwise from a first terminal 712, and a second half having a spiral structure that winds counterclockwise towards a second terminal 714. As illustrated, the first half and the second half of first coil 710 may be symmetric with respect to a line parallel to the x-axis. In one example, the first metal layer may be at or near a surface (e.g., the top surface) of substrate 706, and first terminal 712 and second terminal 714 may include contact pads in the first metal layer. In some examples, the first metal layer may be embedded in substrate 706, and first terminal 712 and second terminal 714 may be connected to contact pads on the surface of substrate 706 through vias, as described above.

A second coil 720 may be formed in the second metal layer and may have a figure-of-B winding structure as described above. Second coil 720 may include a first half having a spiral structure that winds counterclockwise from a first terminal 722, and a second half having a spiral structure that winds counterclockwise towards a second terminal 724. As illustrated, the first half and the second half of second coil 720 may be symmetric with respect to a line parallel to the x-axis. In one example, first terminal 722 may be connected to a contact pad 716 in the first metal layer through a via 730, and second terminal 724 may be connected to a contact pad 718 in the first metal layer through a via 732. In some examples, contact pads 716 and 718 may be on a surface of substrate 706.

FIG. 7B is a perspective view of an example of an isolation circuit 705 that includes a planar transformer having two coils with figure-of-B winding structures formed in three metal layers, according to some examples. Isolation circuit 705 may be similar to isolation circuit 700 and may include an additional metal layer at or near a surface (e.g., a top surface) of a substrate. Similar to isolation circuit 700, isolation circuit 705 may include a package substrate having first section 702 and second section 704 that are separated by a dielectric barrier. First section 702 and second section 704 may be for different power domains, where the ground plane for first section 702 may be isolated from the ground plane for second section 704 by the dielectric barrier. Isolation circuit 705 may include substrate 706 mounted on the package substrate, where substrate 706 may include a planar transformer formed therein to provide a galvanic isolation between first section 702 and second section 704.

In the illustrated example, substrate 706 may include a first metal layer, a second metal layer, and a third metal layer that are separated by dielectric layers. First coil 710 may be formed in the first metal layer, and may have a figure-of-B winding structure as described above. First coil 710 may include a first half having a spiral structure that winds counterclockwise from first terminal 712, and a second half having a spiral structure that winds counterclockwise towards second terminal 714. As illustrated, the first half and the second half of first coil 710 may be symmetric with respect to a line parallel to the x-axis. First terminal 712 of first coil 710 may be connected to a contact pad 740 on the third metal layer at or near the top surface of substrate 706 through a via. In some examples, contact pad 740 may include a bridge structure that may extend beyond the footprint of first coil 710 and second coil 720. Second terminal 714 of first coil 710 may be connected to a contact pad 742 on the third metal layer at or near the top surface of substrate 706 through a via. In some examples, contact pad 742 may include a bridge structure that may extend beyond the footprint of first coil 710 and second coil 720. Contact pads 740 and 742 with portions extended beyond the footprint of second coil 720 may allow flip-chip assembly of a semiconductor die with first coil 710.

Second coil 720 may be formed in the second metal layer and may have a figure-of-B winding structure as described above. Second coil 720 may include a first half having a spiral structure that winds counterclockwise from a first terminal 722, and a second half having a spiral structure that winds counterclockwise towards a second terminal 724. As illustrated, the first half and the second half of second coil 720 may be symmetric with respect to a line parallel to the x-axis. First terminal 722 of second coil 720 may be connected to pad 716 in the first metal layer through a via 730, and may be further connected to a contact pad 744 on the third metal layer at or near the top surface of substrate 706 through a via. Second terminal 724 of second coil 720 may be connected to pad 718 in the first metal layer through a via 732, and may be further connected to a contact pad 746 on the third metal layer at or near the top surface of substrate 706 through a via.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” or “configurable to” perform a task or function may be configured (e.g., programmed and/or hardwired) at a time of manufacturing by a manufacturer to perform the function and/or may be configurable (or reconfigurable) by a user (e.g., by selecting, enabling, activating, or switching to the function) after manufacturing to perform the function and/or other additional or alternative functions. The configuring may be through firmware and/or software programming of the device, through a construction and/or layout of hardware components and interconnections of the device, or a combination thereof. A device “capable of” performing a task or function may be configured or configurable (or both) to perform the task or function.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

In this description, unless otherwise stated, “about,” “approximately” or “substantially” preceding a parameter means being within +/- 10 percent of that parameter or, if the parameter is zero, a reasonable range of values around zero.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein can describe any feature, structure, or characteristic in the singular or can describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Although various examples have been described in detail, it should be understood that various changes, substitutions, and alterations can be made therein without departing from the scope defined by the appended claims. The devices, structures, materials, and processes discussed above are examples. Various examples may omit, substitute, or add various procedures or components as appropriate. Also, features described with respect to certain examples may be combined in various other examples. Different aspects and elements of the examples may be combined in a similar manner. Also, technology evolves and, thus, many of the elements are examples that do not limit the scope of the disclosure to those specific examples.

Specific details are given in the description in order to provide a thorough understanding of the examples. However, examples may be practiced without these specific details. For example, well-known circuits, processes, systems, structures, and techniques may have been shown without unnecessary detail in order to avoid obscuring the examples. This description provides examples only, and is not intended to limit the scope, applicability, or configuration of the invention. Rather, the preceding description of the examples will provide those skilled in the art with an enabling description for implementing various examples. Various changes may be made in the function and arrangement of elements without departing from the spirit and scope of the present disclosure. Modifications are possible in the described examples, and other examples are possible, within the scope of the claims.

What is claimed is:

1. An apparatus comprising:
a substrate including a first metal layer and a second metal layer isolated by one or more dielectric layers,
wherein the first metal layer includes a first coil formed therein, the first coil having two terminals and including two spiral windings that are mirror-symmetric with respect to an axis, each terminal of the two terminals of the first coil being surrounded by a respective spiral winding of the two spiral windings of the first coil, and
wherein the second metal layer includes a second coil formed therein, the second coil having two terminals and including two spiral windings that are mirror-symmetric with respect to the axis, each terminal of the two terminals of the second coil being surrounded by a respective spiral winding of the two spiral windings of the second coil.

2. The apparatus of claim 1, wherein:
the two spiral windings of the first coil are connected together by a coil segment on a same side of the two spiral windings of the first coil; and
the two spiral windings of the second coil are connected together by a coil segment on a same side of the two spiral windings of the second coil.

3. The apparatus of claim 1, further comprising:
a first pair of pads on a surface of the substrate;
a first pair of vias coupling the two terminals of the first coil to the first pair of pads;
a second pair of pads on the surface of the substrate; and
a second pair of vias coupling the two terminals of the second coil to the second pair of pads.

4. The apparatus of claim 1, wherein:
the first coil winds in a same rotational direction between the two terminals of the first coil; and
the second coil winds in a same rotational direction between the two terminals of the second coil.

5. The apparatus of claim 1, wherein each winding of the two spiral windings of the first coil and the two spiral windings of the second coil winds in a rectangular region.

6. The apparatus of claim 1, wherein each winding of the two spiral windings of the first coil and the two spiral windings of the second coil includes more than one turn.

7. The apparatus of claim 1, wherein:
the two terminals of the first coil are offset from a center of the first coil along a direction of the axis; and
the two terminals of the second coil are offset from a center of the second coil along the direction of the axis.

8. The apparatus of claim 7, wherein:
the first coil and the second coil are offset with respect to each other in the direction of the axis;
the two terminals of the first coil are outside of a footprint of the second coil; and
the two terminals of the second coil are outside of a footprint of the first coil.

9. The apparatus of claim 8, further comprising
a first semiconductor die on the substrate, the first semiconductor die overlapping with the two terminals of the first coil and non-overlapping with the second coil; and
a second semiconductor die on the substrate, the second semiconductor die overlapping with the two terminals of the second coil and non-overlapping with the first coil.

10. The apparatus of claim 1, wherein:
the substrate includes a third metal layer, the third metal layer including a pair of bridge structures;
the apparatus includes a pair of vias coupling the two terminals of the first coil to the pair of bridge structures; and
the pair of bridge structures extend beyond a footprint of the first coil and include a pair of pads outside of the footprint of the first coil.

11. An apparatus comprising:
a substrate including a first metal layer, a second metal layer, and one or more dielectric layers between the first metal layer and the second metal layer,
wherein the first metal layer includes a first coil formed therein, the first coil including two spiral windings that are mirror-symmetric with respect to an axis and are connected by a coil segment to form a first figure-of-B winding structure, and
wherein the second metal layer includes a second coil formed therein, the second coil including two spiral windings that are mirror-symmetric with respect to the axis and are connected by a coil segment to form a second figure-of-B winding structure.

12. The apparatus of claim 11, wherein:
the first coil has two terminals, each terminal of the two terminals of the first coil being surrounded by a respective spiral winding of the two spiral windings of the first coil; and
the second coil has two terminals, each terminal of the two terminals of the second coil being surrounded by a respective spiral winding of the two spiral windings of the second coil.

13. The apparatus of claim 12, further comprising:
a first pair of pads on a surface of the substrate;
a first pair of vias coupling the two terminals of the first coil to the first pair of pads;
a second pair of pads on the surface of the substrate; and
a second pair of vias coupling the two terminals of the second coil to the second pair of pads.

14. The apparatus of claim 12, wherein:
the first coil winds in a same rotational direction between the two terminals of the first coil; and
the second coil winds in a same rotational direction between the two terminals of the second coil.

15. The apparatus of claim 12, wherein:
the two terminals of the first coil are offset from a center of the first coil along a direction of the axis; and
the two terminals of the second coil are offset from a center of the second coil along the direction of the axis.

16. The apparatus of claim 15, wherein:
the first coil and the second coil are offset with respect to each other in the direction of the axis;
the two terminals of the first coil are outside of a footprint of the second coil; and
the two terminals of the second coil are outside of a footprint of the first coil.

17. The apparatus of claim 15, further comprising
a first semiconductor die on the substrate, the first semiconductor die overlapping with the two terminals of the first coil and non-overlapping with the second coil; and
a second semiconductor die on the substrate, the second semiconductor die overlapping with the two terminals of the second coil and non-overlapping with the first coil.

18. The apparatus of claim 11, wherein each winding of the two spiral windings of the first coil and the two spiral windings of the second coil includes more than one turn.

19. An apparatus comprising:
a substrate including a first section and a second section isolated from the first section;
a first semiconductor die mounted on the first section;
a second semiconductor die mounted on the second section; and
a transformer coupled between the first semiconductor die and the second semiconductor die, the transformer including:
a first metal layer including a first coil formed therein, the first coil having two terminals and including two spiral windings that are mirror-symmetric with respect to an axis, each terminal of the two terminals of the first coil being surrounded by a respective spiral winding of the two spiral windings of the first coil; and
a second metal layer isolated from the first metal layer by at least one dielectric layer, the second metal layer including a second coil formed therein, the second coil having two terminals and including two spiral windings that are mirror-symmetric with respect to the axis, each terminal of the two terminals of the second coil being surrounded by a respective spiral winding of the two spiral windings of the second coil.

20. The apparatus of claim 19, further comprising:
a third semiconductor die mounted on the first section;
a fourth semiconductor die mounted on the second section; and
one or more isolation devices coupled between the third semiconductor die and the fourth semiconductor die.

21. The apparatus of claim 19, where:
the two terminals of the first coil are offset from a center of the first coil along a direction of the axis;
the two terminals of the second coil are offset from a center of the second coil along the direction of the axis; and
each spiral winding of the two spiral windings of the first coil and the two spiral windings of the second coil includes more than one turn.
